(19) United States
(12) Patent Application Publication
(10) Pub. No.: US 2008/0154618 A1
(43) Pub. Date: Jun. 26, 2008

(54) FACILITATED METHOD TO IMPROVE PROFESSIONAL RELATIONSHIPS

(76) Inventor: Seth Silver, Rochester, NY (US)

Correspondence Address: HISCOCK & BARCLAY, LLP, 2000 HSBC PLAZA, 100 Chestnut Street, ROCHESTER, NY, 14604-2404, US

(21) Appl. No.: 11/614,886

(22) Filed: Dec. 21, 2006

(51) Int. Cl. G06Q 99/00

(52) U.S. Cl. 705/1

(57) ABSTRACT

A behavioral contracting method wherein all parties openly discuss their obligations to and expectations of another party to form ratified explicit lists containing all the obligations the parties have to each other.

### FIELD OF THE INVENTION

This invention relates to a behavioral contracting method to improve the relationship between professionals.

### BACKGROUND OF THE INVENTION

In a professional relationship the difference between what one party expects and another party feels obligated to perform can differ greatly. These expectations and obligations are generally implicit and rarely ever discussed in detail. Neither party may be aware of what is expected from the other party. Generally, a number of implicit expectations go unexpressed, and therefore, can become unmet.

There exists a need for a constructive process that enables all parties to identify mutual obligations and expectations, and that allows for all parties to engage in a safe, routine and non-adversarial review of the relationship.

Furthermore, there is a need for a constructive process that provides a structured approach in which all parties feel equal, that they have been heard, and are respected throughout the process. The process shall provide a channel in which the parties can review the terms of their relationship without embarrassment or retribution.

### SUMMARY OF THE INVENTION

The present invention provides a facilitated, structured and non-adversarial process to enable any professional relationship to start off, and stay, on a positive, open and mutually beneficial path.

The invention comprises a process in which a plurality of parties document their obligations to and expectations of another party. The parties then negotiate covenants based on the documented obligations and expectations that are later ratified. By explicitly documenting the obligations of a party that party's responsibilities become clear.

An advantage of the present invention is that the implicit obligations of a party become explicit in a ratified document that can be posted and reviewed. A further advantage of the present invention is that all of the parties involved in the professional relationship have an opportunity to provide their expectations of another party. An effective negotiation can than take place and the obligations of the parties are documented explicitly, and ratified.

### BRIEF DESCRIPTION OF THE DRAWINGS

The present invention is disclosed with reference to the accompanying drawings, wherein:

FIG. 1 is a diagram of a process to improve professional relationships according to the present invention;

FIG. 2 is a diagram of an additional phase of a process to improve professional relationships according to the present invention; and

Corresponding reference characters indicate corresponding parts throughout the several views. The example set out herein illustrates one embodiment of the invention but should not be construed as limiting the scope of the invention in any manner.

### DETAILED DESCRIPTION

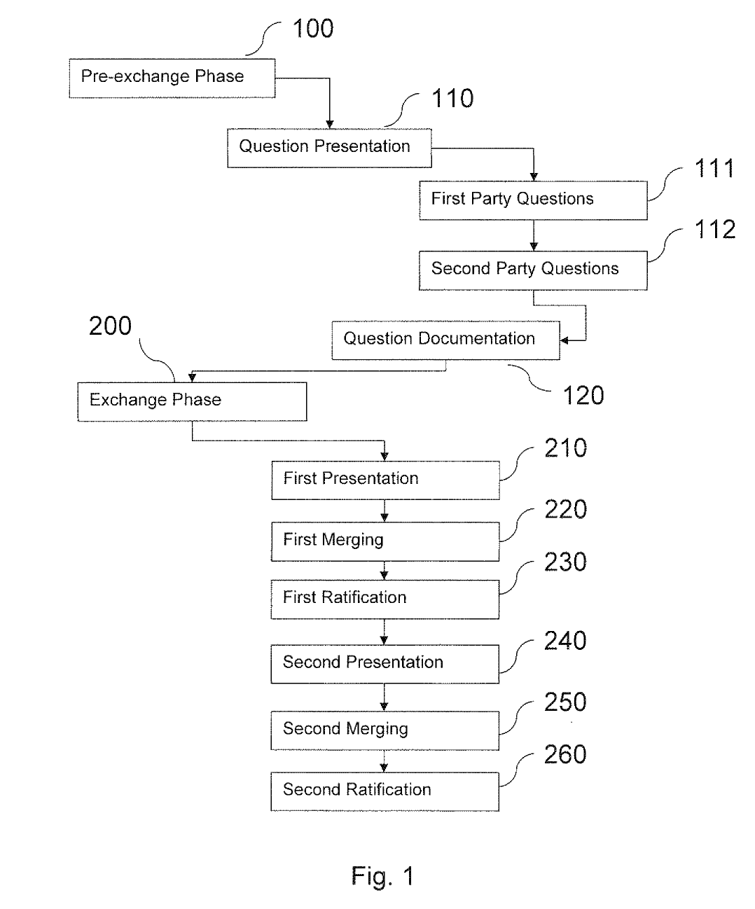

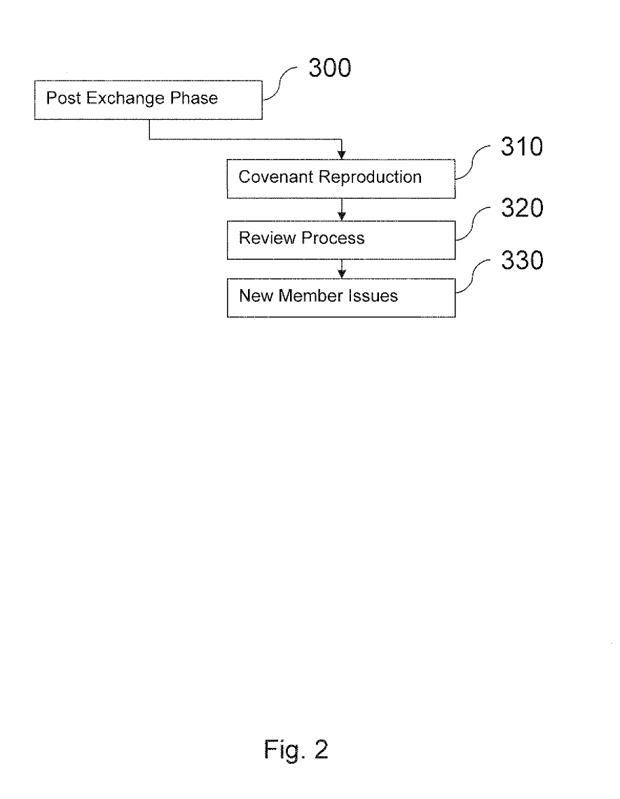

FIGS. 1 through 2 show diagrams of a process to improve professional relationships according to the present invention. The process begins with a pre-exchange phase 100 followed by an exchange phase 200 that may optionally be followed by a post-exchange phase 300. Upon completion of the process ratified documents outline each parties obligations to the other party. Although the process is described as improving the professional relationship between a first party and a second party, it is understood that the process may be utilized between any number of parties. Furthermore, it is understood that although the process is described as being managed by a facilitator, the presence of a facilitator is not a requirement.

During the pre-exchange phase 100 a question presentation phase 110 outlines the questions to be answered by the parties. During the question presentation phase 110 a facilitator presents the first party with a set of first party questions 111. The first party questions 111 may include, but is not limited to, questions relating to: the first party's obligations to the second party; the first party's expectations of the second party; how well the first party is performing on each individual obligation; how well the second party is performing on each individual expectation; and any advice that can improve the relationship between the first party and the second party. The facilitator may then provide sample answers to each of the first party questions 111. Also during the question presentation phase 110 the facilitator presents the second party with a set of second party questions 112. The second party questions 112 may include, but is not limited to, questions relating to: the second party's obligations to the first party; the second party's expectations of the first party; how well the second party is performing on each individual obligation; how well the first party is performing on each individual expectation; and any advice that can improve the relationship between the first party and the second party. The facilitator may then provide sample answers to each of the second party questions 112.

During the pre-exchange phase 100 the facilitator outlines how each party will document their answers to the questions described in the question presentation phase 110 for the documentation phase 120. At least one of the parties relocates to a location physically separate from the other party to document their answers to the question presentation phase 110. Each party then documents their answer to each of the questions from the questions presentation phase 110 on a separate form such that the answers to particular questions may remain concealed, while at the same time the answers to other questions are disclosed. The separate form can be, but is not limited to, flipchart pages, white board areas, chalk board areas, digital pages, slides, pieces of paper, grid areas or any other form which can conceal the answers to at least one of the questions while revealing the answers to another question. Additionally, separate forms may be supplied with generic information such as headings already filled in. For answers in list form it is beneficial to number each answer. Additionally, each parties obligation list should contain more entries than that parties expectation list. When evaluating the obligation and expectation lists an indicator next to each answer is sufficient to rate each individual obligation or expectation. Indicators may include: check marks, up arrows, down arrows, plus signs, minus signs, X's, numeric representations, or any other indication that easily rates evaluation. When evaluating a party with multiple members it is useful to use the “most of us, most of the time” rule. This rule bases the evaluation on the performance of how most of the party performs the majority of the time. This rule may be used by either party to evaluate either another party or itself.

During the exchange phase 200 the parties present their answers from the question documentation phase 110. During the first presentation phase 210 a first party presents their first party obligation list along with the associated evaluation. The first party may provide examples or clarification as needed. A second party then presents their second party expectation list along with the associated evaluations. The second party may provide examples or clarification as needed. After both parties present, the first merging phase 220 takes place by merging the second party expectation list into the first party obligation list to form the first party covenant. This may be accomplished in numerous ways such as asking the second party which items in the second party expectation list are already covered in the first party obligation list, and then focusing on the items that are not already covered. The first party and the second party may then negotiate the addition of items listed on the second party expectation list that are not covered by the items on the first party obligation list. The addition of items to the first party obligation list may be as a new item or as a sub-section of a preexisting item. After assessing each item in the second party expectation list the first party covenant is formed. During the first ratification phase 230 the first party ratifies the first party covenant agreeing to all of the items contained within it.

During the second presentation phase 240 the second party presents their second party obligation list along with the associated evaluation. The second party may provide examples or clarification as needed. A first party then presents their first party expectation list along with the associated evaluations. The first party may provide examples or clarification as needed. After both parties present the second merging phase 250 takes place by merging the first party expectation list into the second party obligation list to form the second party covenant. This may be accomplished in numerous ways such as asking the first party which items in the first party expectation list are already covered in the second party obligation list, and then focusing on the items that are not already covered. The first party and the second party may then negotiate the addition of items listed on the first party expectation list that are not covered by the items on the second party obligation list. The addition of items to the second party obligation list may be as a new item or as a sub-section of a preexisting item. After assessing each item in the first party expectation list the second party covenant is formed. During the second ratification phase 260 the second party ratifies the second party covenant agreeing to all of the items contained within it.

During the exchange phase 200, in addition to ratifying the covenants, the first and second parties can review any additional answers to questions from the question documentation phase 120 that have not yet been covered. This may include any advice on how to further improved the professional relationship, any short or long term goals that the party may have, or any other items not previously covered.

Upon the conclusion of the exchange phase 200 the parties participate in the post-exchange phase 300. During the post-exchange phase 300 the parties may discuss, in any particular order, topics relating to how best to handle future situations. During the covenant reproduction discussion 310 the parties will discuss the best method to reproduce the covenants so that they may be easily accessed and read. This may include where the covenants are posted; if they will be made into posters or packets; how they will be distributed; if they are private or public; who should have access to the covenants; or any other item relating to the reproduction of the covenants.

The parties may also discuss the review process 320 which may cover how frequently the covenants are reviewed, the process for assessing performance, if performance will be assessed as a group or as one-on-one meetings, if any additional items need to be added to the covenants if peer review is appropriate for a party that contains multiple members, or any other issues relating to reviewing the convents.

The parties may discuss any new member issues 330 which deal with how to introduce new members of a party to the covenant. This may include how to present the covenants to the new member, if the new member is required to ratify the covenant, will new member form a new covenant, or any other issues relating to the addition of new members to a party.

It is understood that the process has been described as improving the professional relationship between two parties and may be used to improve the professional relationship between any number of parties. It is understood that the parties may be any person, entity or group of persons in which a professional relationship exists including but not limited to; supervisors, managers, or team leaders and their team; executive teams and middle mangers; staff groups and their customers; departments that do business with each other; sales executives and their external customers; senior level and junior level professionals; social service provider and their clients; a board of directors and their executive team; professors or teachers and their students; business owners and their staff; or any other parties in which a professional relationship may be improved.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. A behavioral contracting method comprising following and completing the activities of a plurality of phases, wherein:
a. a pre-exchange phase comprising the steps of:
i. presenting a first party with a set of first party questions comprising questions relating to:
1. what are said first party's obligations;
2. what are said first party's expectations of a second party;
3. how does said first party evaluate the performance of each individual first party obligation and each individual second party expectation
ii. presenting a second party with a set of second party questions comprising questions relating to:
1. what are said second party's obligations;
2. what are said second party's expectations of said first party; and
3. how does said second party evaluate the performance of each individual second party obligation and each individual first party expectation
iii. said first party documents answers to each of said first party questions; and
iv. said second party documents answers to each of said second party questions
b. an exchange phase between said first party and second party comprising the steps of:
i. presenting said first party's obligations;
ii. presenting the evaluation of said each individual first party obligation;
iii. presenting said second party's expectations;
iv. presenting the evaluation of said each individual second party expectation;
v. merging said second party's expectations into said first party's obligations, creating the first party's covenant;
vi. said first party ratifies said first party's covenant;
vii. presenting said second party's obligations;
viii. presenting the evaluations of said each individual second party obligation;
ix. presenting said first party's expectations;
x. presenting the evaluation of said each individual first party expectation;
xi. merging said first party's expectations into said second party's obligations, creating the second party's covenant; and
xii. said second party ratifies said second party's covenant;

2. The behavioral contracting method of claim 1 further comprising a post-exchange phase comprising the steps of:
a. determining how to reproduce said covenants;
b. determining when said covenants will be reviewed; and
c. determining how to present said covenants to new members.

3. The behavioral contracting method of claim 1 wherein said first party documents answers to each of said first party questions in a location physically separated from said second party.

4. The behavioral contracting method of claim 3 wherein said second party documents answers to each of said second party questions in a location physically separated from said first party.

5. The behavioral contracting method of claim 1 wherein said set of first party questions further comprises a question relating to what suggestions said first party has that can improve the relationship between said first party and said second party.

6. The behavioral contracting method of claim 5 wherein said set of second party questions further comprises a question relating to what suggestions said second party has that can improve the relationship between said second party and said first party.

7. The behavioral contracting method of claim 6 wherein said exchange phase further comprises the steps of:
a. presenting said first party's suggestions on how to improve said relationship between said first party and said second party.
b. presenting said second party's suggestions on how to improve said relationship between said second party and said first party.

8. The behavioral contracting method of claim 1 wherein evaluating the performance of each individual obligation and expectation is accomplished by the “most of us, most of the time” rule.

9. The behavioral contracting method of claim 1 wherein said first party's obligations has more items than said first party's expectations.

10. The behavioral contracting method of claim 9 wherein said second party's obligations has more items than said second party's expectations.

11. The behavioral contracting method of claim 1 wherein each obligation and each expectation is numbered.

12. The behavioral contracting method of claim 1 wherein said first party documents answers to each of said first party questions on a form.

13. The behavioral contracting method of claim 12 wherein said form is selected from the group consisting of flip chart pages, white board areas, chalk board areas, digital pages, slides, pieces of paper and grid areas.

14. The behavioral contracting method of claim 13 wherein said second party documents answers to each of said second party questions on a form.

15. The behavioral contracting method of claim 14 wherein said form is selected from the group consisting of flip chart pages, white board areas, chalk board areas, digital pages, slides, pieces of paper and grid areas.

16. The behavioral contracting method of claim 1 wherein when said first party comprises multiple members a different member of said first party documents the response for each of said second party questions.

17. The behavioral contracting method of claim 1 wherein when said second party comprises multiple members a different member of said second party documents the response for each of said second party questions.

18. The behavioral contracting method of claim 1 wherein said first party is in a supervisory position of said second party.

19. The behavioral contracting method of claim 1 wherein a facilitator presents said first party questions and said second party questions.

20. The behavioral contracting method of claim 1 wherein said exchange phase is conducted by a facilitator.
